(19) United States
(12) Patent Application Publication
(10) Pub. No.: US 2013/0082880 A1
(43) Pub. Date: Apr. 4, 2013

(54) PRINTED ANTENNA

(71) Applicants: ZHI-CHENG YU, Shanghai (CN); CHENG-QIU WEI, Shanghai (CN)

(72) Inventors: ZHI-CHENG YU, Shanghai (CN); CHENG-QIU WEI, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/597,283

(22) Filed: Aug. 29, 2012

(30) Foreign Application Priority Data
Sep. 30, 2011 (CN) 201120373001.2

(51) Int. Cl. H01Q 1/38

(52) U.S. Cl. 343/700 MS

(57) ABSTRACT

A printed antenna, disposed on a substrate including a first surface and a second surface, includes a plurality of holes, a radiating body, and a feeding portion. The radiating body includes a first radiator arranged on the first surface and a second radiator arranged on the second surface. The first radiator includes a plurality of first radiating portions spaced apart from each other and positioned between two adjacent holes on the first surface. The second radiator includes a plurality of second radiating portions spaced apart from each other and positioned between two adjacent holes on the first surface. The plurality of first radiating portions and the plurality of second radiating portions are put end to end via the plurality of holes from the first surface to the second surface.

### BACKGROUND

1. Technical Field

The present disclosure relates to antennas, and more particularly to a printed antenna.

2. Description of Related Art

In order to make them more convenient, wireless communication devices are generally small in size. As antennas are necessary components in the wireless communication devices for transceiving electromagnetic signals, one solution for maintaining the small size of the electronic devices is to reduce the dimensions of the antennas. Printed antennas in current use are often rectangular, with the result that the profile of the printed antennas cannot be further reduced.

Therefore, a need exists in the industry to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic plan view of a printed antenna disposed on a first surface of a substrate in accordance with the present disclosure.

FIG. 2 is a schematic plan view of the printed antenna disposed on a second surface of the substrate in accordance with the present disclosure.

FIG. 3 is a projection plan view of the printed antenna disposed on the second surface superimposed on the printed antenna disposed on the first surface.

FIG. 4 is a schematic plan view illustrating dimensions of the printed antenna of FIG. 1.

FIG. 5 is a schematic plan view illustrating dimensions of the printed antenna of FIG. 2.

FIG. 6 is a graph of test results showing a return loss of the printed antenna in accordance with the present disclosure.

### DETAILED DESCRIPTION

The disclosure is illustrated by way of example and not by way of limitation in the figures of the accompanying drawings in which like reference numerals indicate the same or similar elements. It should be noted that references to “an” or “one” embodiment in this disclosure are not necessarily to the same embodiment, and such references can mean “at least one.”

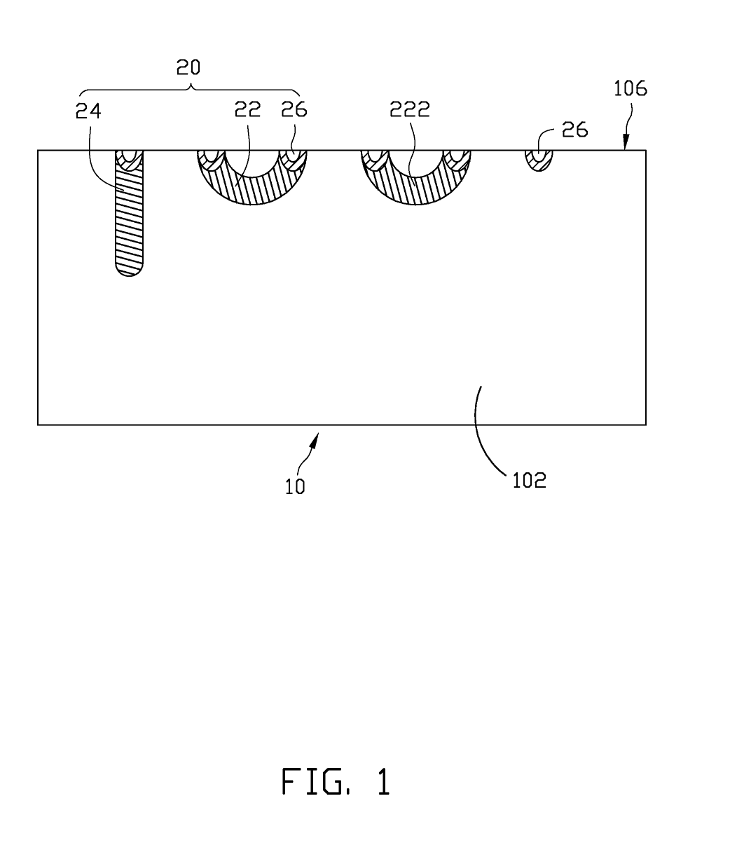

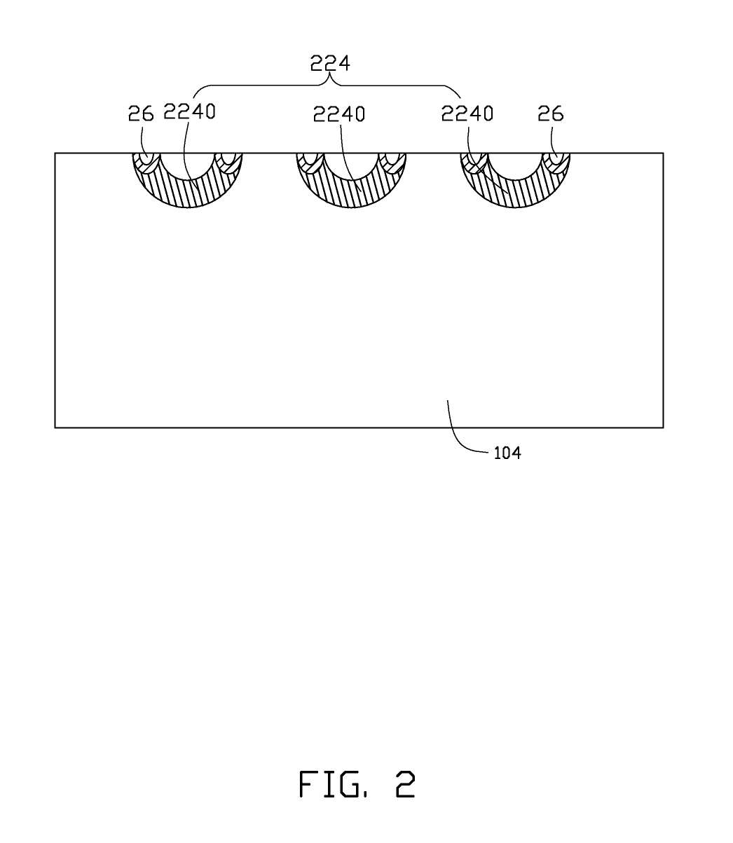

Referring to FIG. 1 and FIG. 2, a printed antenna 20 is arranged on a substrate 10. In other embodiments, an assembly includes the substrate 10 and the printed antenna 20 arranged on the substrate 10.

The substrate 10 includes a first surface 102, a second surface 104 parallel to the first surface 102, and an outer 106 connecting the first surface 102 and the second surface 104.

The printed antenna 20 includes a radiating body 22, a feeding portion 24 arranged on the first surface 102, and a plurality of holes 26 electrically connected to the radiating body 22 and the feeding portion 24.

The radiating body 22 is electrically connected to the feeding portion 24 to transmit and receive radio frequency (RF) signals. The radiating body 22 includes a first radiator 222 arranged on the first surface 102 and a second radiator 224 arranged on the second surface 104.

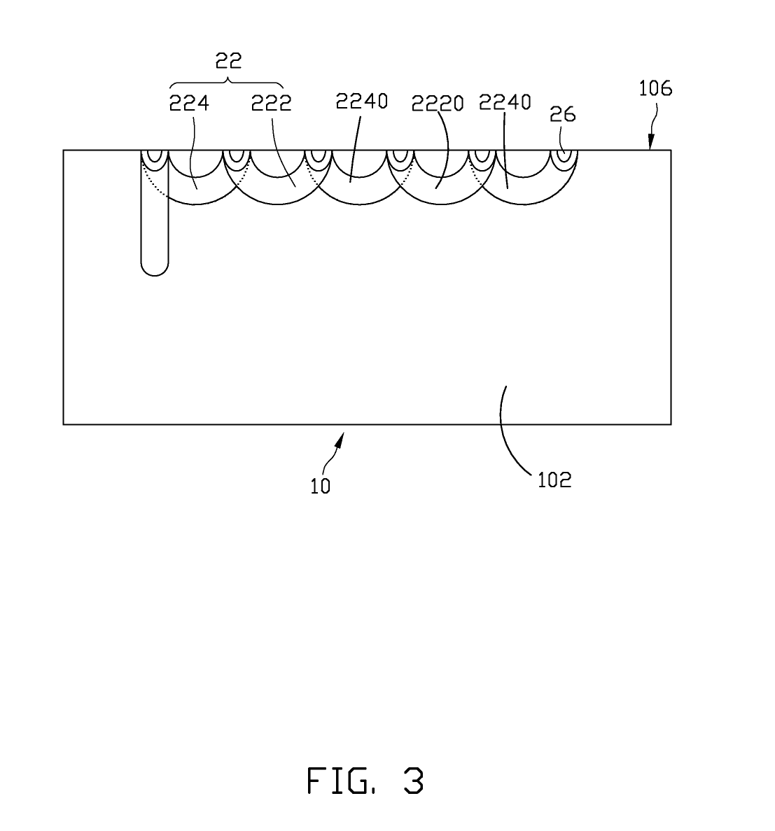

The first radiator 222 includes a plurality of annular first radiating portions 2220 (referring to FIG. 3) spaced apart from each other, and each of the plurality of first radiating portions 2220 is positioned between two adjacent holes 26 on the first surface 102. Two ends of each of the plurality of first radiating portions 2220 are in communication with the two adjacent holes 26 on the first surface 102. Each of the plurality of first radiating portions 2220 is symmetrical about a central line of the two adjacent holes 26 on the first surface 102. In the illustrated embodiment, the number of the plurality of first radiating portions 2220 may be two, but the disclosure is not limited thereto.

The second radiator 224 includes a plurality of annular second radiating portions 2240 spaced apart from each other, and each of the plurality of second radiating portions 2240 is positioned between two adjacent holes 26 on the second surface 104. Two ends of each of the plurality of second radiating portions 2240 are in communication with the two adjacent holes 26 on the second surface 104. Each of the plurality of second radiating portions 2240 is symmetrical about a central line of the two adjacent holes 26 on the second surface 104. In the illustrated embodiment, one of the two adjacent holes 26 on the first surface 102 is different from one of the two adjacent holes 26 on the second surface 104 next to the two adjacent holes 26 on the first surface 102, and the two adjacent holes 26 on the first surface 102 and the two adjacent holes 26 on the second surface 104 next to the two adjacent holes 26 on the first surface 102 have a same hole 26. That is, the two adjacent holes 26 on the first surface 102 are partly different from the two adjacent holes 26 on the second surface 104 next to the two adjacent holes 26 on the first surface 102. The plurality of first radiating portions 2220 and the plurality of second radiating portions 2240 are put end to end via the plurality of holes 26 from the first surface 102 to the second surface 104, namely, the plurality of first radiating portions 2220 and the plurality of second radiating portions 2240 are linked together by the plurality of holes 26 from the first surface 102 to the second surface 104. Thus the first radiator 222 arranged on the first surface 102 and the second radiator 224 arranged on the second surface 104 form a continuous meandering radiator via the plurality of holes 26 from the first surface 102 to the second surface 104, that is, the radiating body 22 has a meandering profile from the first surface 102 to the second surface 104 via the plurality of holes 26. In the illustrated embodiment, the number of the second radiating portions 2240 may be three, but the disclosure is not limited thereto.

FIG. 3 is a projection plan view of the printed antenna 20 disposed on the second surface 104 of the substrate 10 superimposed on the printed antenna 20 disposed on the first surface 102 of the substrate 10. Projections of the plurality of first radiating portions 2220 on the substrate 10 is spaced apart from each other, and each of the projections of the plurality of first radiating portions 2220 is arranged between the two adjacent holes 26 on the first surface 102. Two ends of each of the projections of the plurality of first radiating portions 2220 on the substrate 10 are in communication with the two adjacent holes 26 on the first surface 102. Projections of the plurality of second radiating portions 2240 on the substrate 10 is spaced apart from each other, and each of the projections of the plurality of second radiating portions 2240 on the substrate 10 is arranged between the two adjacent holes 26 on the second surface 104. Two ends of each of the projections of the plurality of second radiating portions 2240 on the substrate 10 are in communication with the two adjacent holes 26 on the second surface 104. Each of the projections of the plurality of first radiating portions 2220 on the substrate 10 overlaps each of the projections of the plurality of the second radiating portions 2240 on the substrate 10. The projections of the plurality of first radiating portions 2220 and the projections of the plurality of second radiating portions 2240 are put end to end via the plurality of holes 26, namely, the projections of the plurality of first radiating portions 2220 and the projections of the plurality of second radiating portions 2240 are linked together by the plurality of holes 26. In the illustrated embodiment, each of the projections of the plurality of first radiating portions 2220 and the plurality of second radiating portions 2240 are half-circular annular segments. In other embodiments, the plurality of first radiating portions 2220 and the plurality of second radiating portions 2240 may be S-shaped, W-shaped annular segments.

The feeding portion 24 is in communication with one of the plurality of holes 26 and one end of one of the plurality of second radiating portions 2240 to feed signals to the radiating body 22. In the illustrated embodiment, the feeding portion 24 may be a 50Ω transmission line.

The plurality of holes 26 extend from first surface 102 to the second surface 104, and an inner wall of each of the plurality of holes 26 is plated by conductive material, so that the plurality of holes 26 are electrically connected to the plurality of first radiating portions 2220 and the plurality of second radiating portions 2224. In the illustrated embodiment, the plurality of holes 26 are arranged in the outer 106 of the substrate 10. A cross-section of each of the plurality of holes 26 is half-circular.

In other embodiments, the plurality of holes 26 may be arranged within an interior of the substrate 10. A cross-section of each of the plurality of holes 26 may be circular.

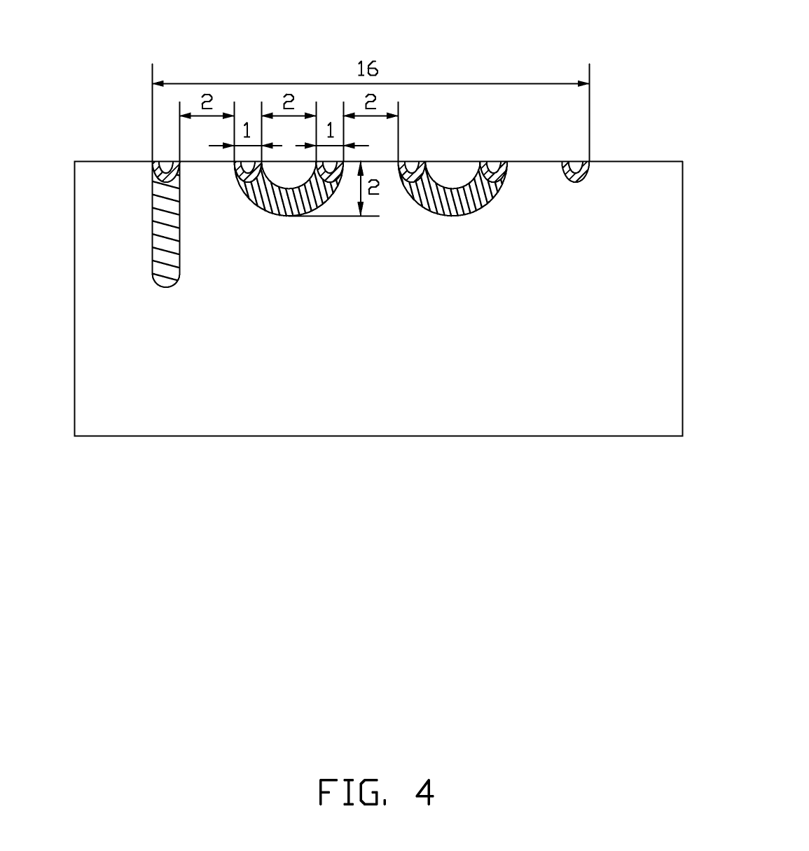

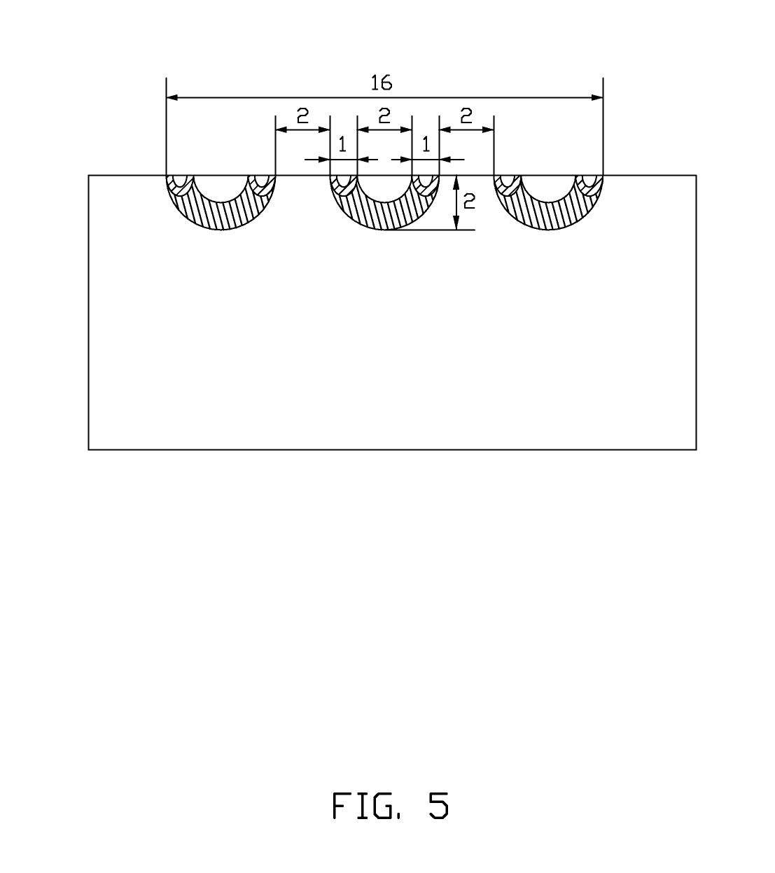

Referring to FIG. 4 and FIG. 5, in the illustrated embodiment, a length of radiating body 22 is generally 16.0 mm, and a width of the radiating body 22 is generally 2.0 mm. A diameter of each of the plurality of holes 26 is generally 1.0 mm. An inner radius of each of the plurality of first radiating portions 2220 is generally 1.0 mm, and an outer radius of each of the plurality of first radiating portions 2220 is generally 1.0 mm. Each of the plurality of first radiating portions 2220 and each of the plurality of second radiating portions 2240 have the same inner and outer radii. A distance of two adjacent first radiating portions 2220 is generally 2.0 mm, and a distance of two adjacent second radiating portions 2240 is generally 2.0 mm.

In the illustrated embodiment, the first radiator 222 and the second radiator 224 are arranged on different surfaces of the substrate 10, therefore, the printed antenna 20 has a lower profile and a smaller size. The profile and size of the printed antenna 20 are further reduced because of the meandering profile of the radiating body 22 from the first surface 102 to the second surface 104.

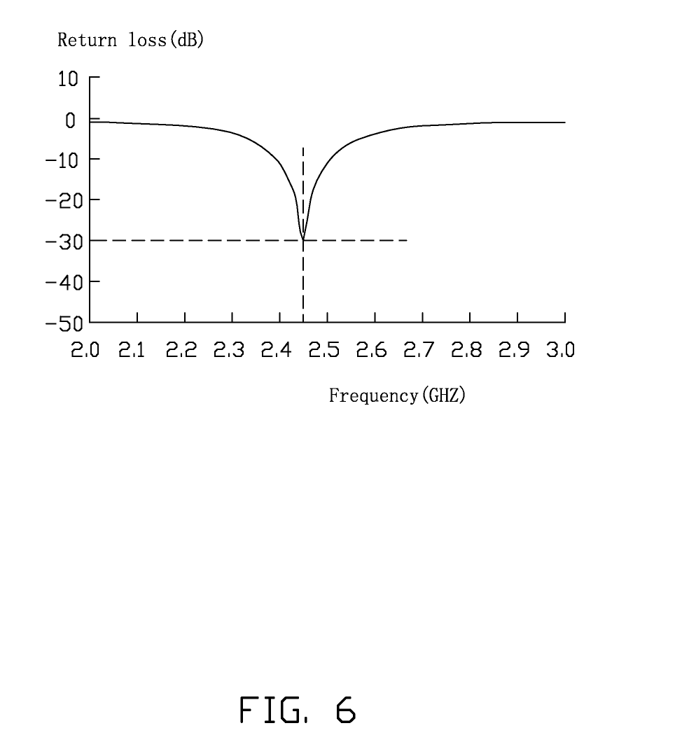

FIG. 6 is a graph of test results showing a return loss of the printed antenna 20 when used in a wireless communication system, with the return loss as its vertical coordinate and the frequency as its horizontal coordinate. When the printed antenna 20 operates at frequency bands of 2.4-2.5 GHz, the return loss drops below −10 dB, compliant with standard practical requirements.

With the above-described configuration, the printed antenna 20 has a lower profile, a smaller size, and a better return loss.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A printed antenna disposed on a substrate comprising a first surface and a second surface, the printed antenna comprising:
a plurality of holes extending from the first surface to the second surface;
a radiating body that transmits and receives radio frequency (RF) signals, the radiating body comprising a first radiator arranged on the first surface and a second radiator arranged on the second surface, the first radiator comprising a plurality of first radiating portions spaced apart from each other and positioned between two adjacent holes on the first surface, the second radiator comprising a plurality of second radiating portions spaced apart from each other and positioned between two adjacent holes on the second surface; and
a feeding portion electrically connected to the plurality of holes to feed signals;
wherein the plurality of first radiating portions and the plurality of second radiating portions are put end to end via the plurality of holes from the first surface to the second surface.

2. The printed antenna of claim 1, wherein projection of each of the plurality of first radiating portions on the substrate overlaps projection of each of the plurality of the second radiating portions on the substrate.

3. The printed antenna of claim 2, wherein the projections of the plurality of first radiating portions on the substrate and the projections of the plurality of the second radiating portions on the substrate are put end to end.

4. The printed antenna of claim 1, wherein each of the plurality of first radiating portion and each of the plurality of the second radiating portions are annular.

5. The printed antenna of claim 4, wherein each of the plurality of first radiating portions and each of the plurality of second radiating portions have a same inner and outer radii.

6. The printed antenna of claim 1, wherein the feeding portion is arranged on the first surface and in communication with one of the plurality of holes.

7. The printed antenna of claim 6, wherein the feeding portion is in communication with one end of one of the plurality of second radiating portions to feed signals to the radiating body.

8. An assembly, comprising:
a substrate comprising a first surface and a second surface parallel to the first surface; and
an antenna disposed on the substrate, the antenna comprising a plurality of holes extending from the first surface to the second surface, a feeding portion to feed signals, and a radiating body electrically connected to the feeding portion to transmit and receive radio frequency (RF) signals, the radiating body comprising a first radiator arranged on the first surface and a second radiator arranged on the second surface, the first radiator comprising a plurality of first radiating portions spaced apart from each other and positioned between two adjacent holes on the first surface, the second radiator comprising a plurality of second radiating portions spaced apart from each other and positioned between two adjacent holes on the second surface;
wherein projection of each of the plurality of first radiating portions on the substrate overlaps projection of each of the plurality of the second radiating portions on the substrate.

9. The assembly of claim 8, wherein two ends of each of the plurality of first radiating portions are in communication with the two adjacent holes on the first surface, and two ends of each of the plurality of second radiating portions are in communication with the two adjacent holes on the second surface.

10. The assembly of claim 9, wherein the radiating body has a meandering profile from the first surface to the second surface via the plurality of holes.

11. The assembly of claim 8, wherein the plurality of first radiating portions and the plurality of second radiating portions are put end to end via the plurality of holes from the first surface to the second surface.

12. The assembly of claim 8, wherein two ends of each of the projections of the plurality of first radiating portions on the substrate are in communication with the two adjacent holes on the first surface, and two ends of each of the projections of the plurality of second radiating portions on the substrate are in communication with the two adjacent holes on the second surface.

13. The assembly of claim 8, wherein the projections of the plurality of first radiating portions on the substrate and the projections of the plurality of second radiating portions on the substrate are put end to end.

14. An assembly, comprising:
a substrate comprising a first surface and a second surface parallel to the first surface; and
an antenna disposed on the substrate, the antenna comprising a plurality of holes extending from the first surface to the second surface, a feeding portion electrically connected to the plurality of holes, and a radiating body electrically connected to the feeding portion and the plurality of holes to transmit and receive radio frequency (RF) signals, the radiating body comprising a first radiator arranged on the first surface and a second radiator arranged on the second surface, the first radiator comprising a plurality of first radiating portions positioned between two adjacent holes on the first surface and spaced apart from each other, the second radiator comprising a plurality of second radiating portions positioned between two adjacent holes on the second surface and spaced apart from each other;
wherein the plurality of first radiating portions arranged on the first surface and the plurality of second radiating portions arranged on the second surface form a meandering radiator via the plurality of holes from the first surface to the second surface.

15. The assembly of claim 14, wherein the plurality of first radiating portions and the plurality of second radiating portions are put end to end via the plurality of holes from the first surface to the second surface.

16. The assembly of claim 14, wherein projection of each of the plurality of first radiating portions on the substrate overlaps projection of each of the plurality of the second radiating portions on the substrate.

17. The assembly of claim 16, wherein the projections of the plurality of first radiating portions on the substrate and the projections of the plurality of the second radiating portions on the substrate are put end to end.

18. The assembly of claim 16, wherein two ends of each of the projections of the plurality of first radiating portions on the substrate are in communication with the two adjacent holes on the first surface, and two ends of each of the projections of the plurality of second radiating portions on the substrate are in communication with the two adjacent holes on the second surface.

19. The assembly of claim 14, wherein two ends of each of the plurality of first radiating portions are in communication with the two adjacent holes on the first surface, and two ends of each of the plurality of second radiating portions are in communication with the two adjacent holes on the second surface.
